(19) United States
(12) Patent Application Publication
(10) Pub. No.: US 2011/0148186 A1
(43) Pub. Date: Jun. 23, 2011

(54) METHOD AND DEVICE FOR ACTIVATING A SWITHCHOVER VALVE IN THE CONTEXT OF A HILL-HOLDING FUNCTION

(76) Inventors: Michael Reichert, Tamm (DE); Michael Kunz, Steinheim An derMurr (DE); Raphael Oliveira, Freiberg A.N. (DE); Frank Kneip, Ilsfeld (DE)

(21) Appl. No.: 12/736,047

(22) PCT Filed: Dec. 16, 2008
(86) PCT No.: PCT/EP2008/067618

§ 371 Date: Feb. 25, 2011

(30) Foreign Application Priority Data
Mar. 3, 2008 (DE) 102008012353.6

(51) Int. Cl. B60T 8/36; B60T 8/32; B60T 7/12

(52) U.S. Cl. 303/191

(57) ABSTRACT

A method for activating the switchover valve of a brake circuit which is configured to build up brake pressure independently of the driver within the context of a vehicle standstill-holding function, is described, in which: the vehicle standstill is detected and, as long as the driver operates the brake during the standstill, the switchover valve is activated via a first current intensity other than zero (iUSV1) during a first phase; and the switchover valve is activated via a second current intensity other than zero (iUSV2) during a subsequent second phase; the first current intensity being selected in such a way that the switchover valve just closes at this current intensity; and the second current intensity being selected in such a way that the switchover valve is securely closed at this current intensity.

### FIELD OF THE INVENTION

The present invention relates to a method and a device for activating the switchover valve of a brake circuit.

### BACKGROUND INFORMATION

Hill-holding control functions (HHC) are provided in various ESP systems (ESP=Electronic Stability Program). This function makes it easier to start on a hill. For this purpose, the pressure is maintained for up to approximately 2 more seconds after the brake has been released. During this time interval, the driver can start the vehicle without rolling back.

### SUMMARY OF THE INVENTION

The exemplary embodiments and/or exemplary methods of the present invention relates to a method for activating the switchover valve of a brake circuit which is configured to build up brake pressure independently of the driver within the context of a vehicle standstill holding function, in which
the vehicle standstill is detected and, as long as the driver operates the brake during the standstill,
the switchover valve is activated via a first current intensity other than zero during a first phase, and
the switchover valve is activated via a second current intensity other than zero and different from the first current intensity during a subsequent second phase.

This makes it possible to implement a hill-holding function in an energy-efficient and thus thermally non-critical manner.

An advantageous embodiment is characterized in that
the first current intensity is selected in such a way that the switchover valve just closes at this current intensity, and
the second current intensity is selected in such a way that the switchover valve is securely closed at this current intensity.

An advantageous embodiment of the present invention is characterized in that
the switchover valve is a open valve when currentless, and
the second current intensity is higher than the first current intensity.

An advantageous embodiment of the present invention is characterized in that the transition to the second phase takes place when the driver reduces the intensity of brake operation.

Due to the reduction in brake operation, a pressure difference builds up at the switchover valve. The transition to the second phase ensures that the switchover valve remains closed even against this pressure difference.

An advantageous embodiment of the present invention is characterized in that the first current intensity is selected in such a way that the switchover valve just closes when a predefined pressure difference is present at the valve.

An advantageous embodiment of the present invention is characterized in that the predefined pressure difference is a small pressure difference.

An advantageous embodiment of the present invention is characterized in that the predefined pressure difference is a pressure difference between 2 bar and 8 bar, in particular 5 bar.

An advantageous embodiment of the present invention is characterized in that the brake circuit is a hydraulic brake circuit.

The exemplary embodiments and/or exemplary methods of the present invention also relate to a device for activating the switchover valve of a brake circuit which is configured to build up brake pressure independently of the driver within the context of a vehicle standstill holding function, including
a standstill detection arrangement with the aid of which the vehicle standstill is detected;
a brake operation detection arrangement with the aid of which the operation of the brake by the driver is detected;
an energizing arrangement with the aid of which the switchover valve is energized; the energizing arrangement being configured in such a way that, as long as the driver operates the brake during the standstill,
the switchover valve is activated via a first current intensity other than zero during a first phase and
the switchover valve is activated via a second current intensity other than zero and different than the first current intensity during a subsequent second phase.

The advantageous embodiments of the method according to the present invention are, of course, also expressed as advantageous embodiments of the device according to the present invention and vice versa.

The drawings includes FIGS. 1 through 5.

### BRIEF DESCRIPTION OF THE DRAWINGS

FIG. 1 shows the topological structure of a brake circuit suitable for a hill-holding function.

FIG. 2 shows the time curve of different variables in a first specific embodiment for activating the switchover valve (USV).

FIG. 3 shows the time curve of different variables in a second specific embodiment for activating the switchover valve (USV).

FIG. 4 shows the time curve of different variables in a third specific embodiment for activating the switchover valve (USV).

FIG. 5 shows the sequence of the method according to the present invention in a flow chart.

### DETAILED DESCRIPTION

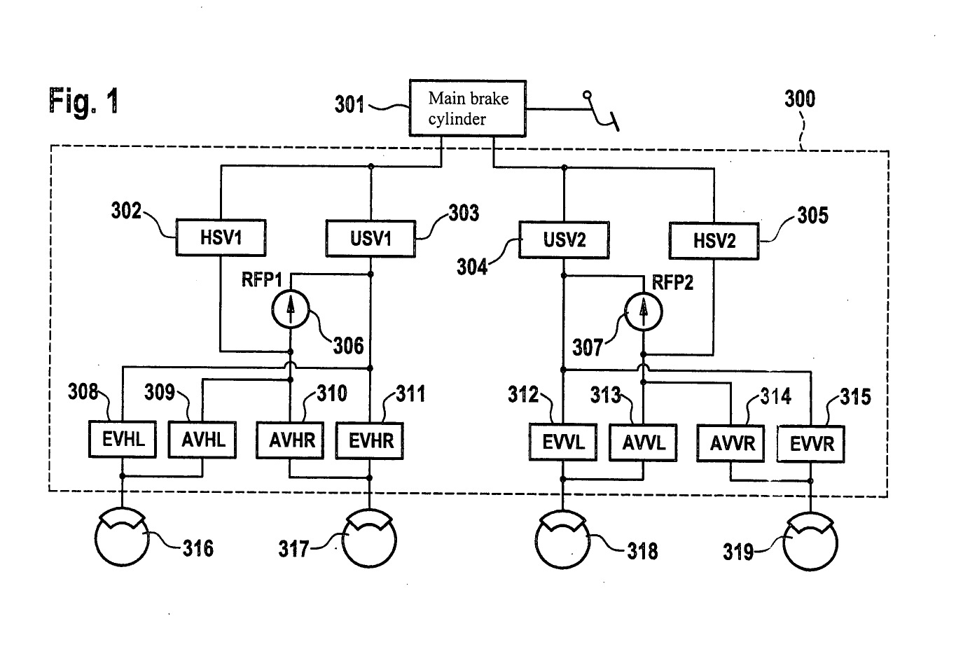

FIG. 1 shows a schematic representation of the brake system of a vehicle equipped with an electronic stability program. All components not essential for comprehension have been omitted. A brake system having two brake circuits are illustrated: Brake circuit 1 is the left branch in FIG. 1 (it is also referred to as a floating circuit), while the right branch is brake circuit 2 (it is also referred to as the push rod circuit). Brake circuit 1 thus extends over the rear wheels and brake circuit 2 extends over the front wheels. This distribution is also referred to as an II distribution. Of course, other distributions are also conceivable. (Details may be found, for example, in “Kraftfahrtechnisches Taschenbuch” (Automotive Handbook), 23rd Edition, ISBN-Nr. 3-528-03876-4, pp. 654-655).

Before addressing the processes in the brake system, the individual blocks are first briefly presented:
300: Hydraulic brake pressure regulating unit
301: Main brake cylinder
302: HSV1 (=high-pressure switching valve of brake circuit 1)
303: USV1 (=switchover valve of brake circuit 1)
306: RFP1 (=return pump of brake circuit 1)
308: EVHL (=left rear inlet valve, i.e., on the brake of the left rear wheel)
309: AVHL (=left rear discharge valve)
311: EVHR (=right rear inlet valve)
310: AVHR (=right rear discharge valve)
316: Wheel brake of the left rear wheel
317: Wheel brake of the right rear wheel
305: HSV2 (=high-pressure switching valve of brake circuit 2)
304: USV2 (=switchover valve of brake circuit 2)
307: RFP2 (=return pump of brake circuit 2)
312: EVVL (=left front inlet valve)
313: AVVL (=left front discharge valve)
315: EVVR (=right front inlet valve)
314: AVVR (=right front discharge valve)
318: Wheel brake of the left front wheel
319: Wheel brake of the right front wheel

The two return pumps are driven by a common motor, i.e., they are placed into operation in parallel.

Two lines run from main brake cylinder 301 to brake pressure regulating unit 300. Branching to high-pressure switching valves 302 and 305 and to switchover valves 303 and 304 takes place therein. High-pressure switching valve 302 is connected to discharge valves 309 and 310 as well as to the suction side of return pump 306. Switchover valve 303 is connected to inlet valves 308 and 311 as well as to the delivery side of return pump 306. The output side of inlet valve 308 and the input side of discharge valve 309 are connected to wheel brake 316, while inlet valve 311 and discharge valve 310 are connected to wheel brake 317.

High-pressure switching valve 305 is connected to discharge valves 313 and 314 as well as to the suction side of return pump 307. Switchover valve 304 is connected to inlet valves 312 and 315 as well as to the delivery side of return pump 307. The output side of inlet valve 312 and the input side of discharge valve 313 are connected to wheel brake 318, while inlet valve 315 and discharge valve 314 are connected to wheel brake 319.

Return pump 306 is located between switchover valve 303 (delivery side) and discharge valve 310 (suction side); return pump 307 is located between switchover valve 304 (delivery side) and discharge valve 313 (suction side).

In a first specific embodiment, switchover valves 303 and 304 are closed by the required setpoint current as soon as the vehicle has reached a standstill and the driver has operated the brake pedal.

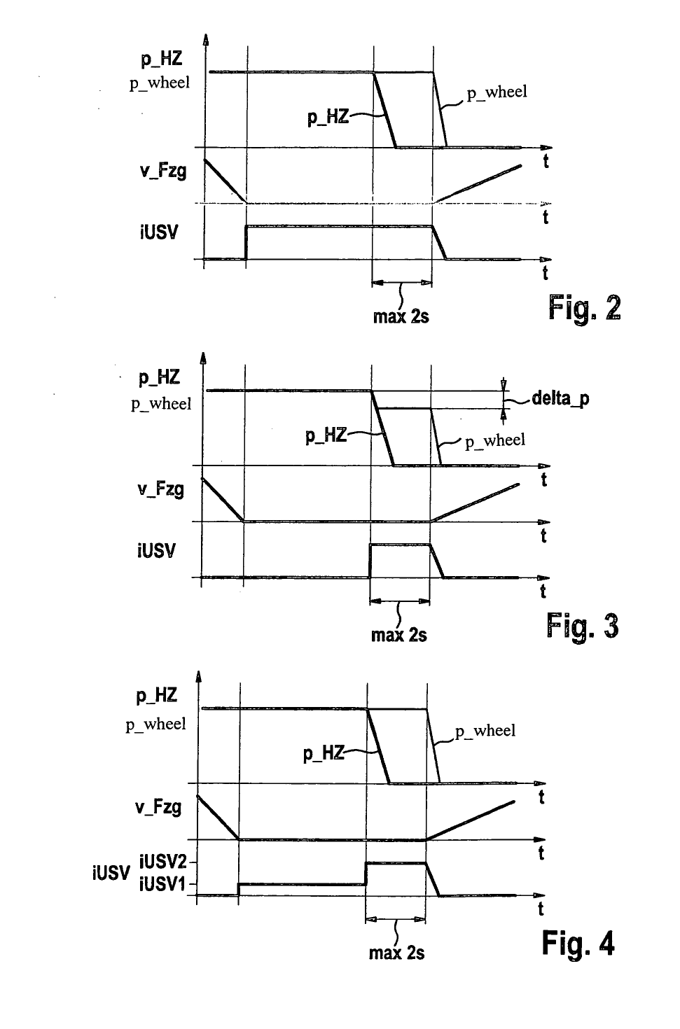

In FIG. 2, time t is plotted in the abscissa direction. The switchover valves are closed by the required setpoint current iUSV as soon as the vehicle has reached a standstill (v_Fzg=0) and the driver has operated the brake pedal. After the driver has released the brake, the switchover valve continues to be energized for up to 2 more seconds, which produces a time delay between the falling edge of p_HZ (p_HZ is the hydraulic pressure in the main brake cylinder) and the falling edge of p_wheel (p_wheel is the hydraulic pressure in the wheel brake cylinder). This version of the function completely prevents the vehicle from rolling backwards and is very comfortable. However, energizing of the switchover valves, which under some circumstances may last a very long time and which may cause thermal problems and thus the need for complex heat removal measures, has a negative effect.

A further version of the function does not close the switchover valves until the driver releases the brake. This is shown in FIG. 3. Due to the switchover valve switching times, however, a pressure drop delta_p may occur, which may then result in brief, yet uncomfortable, backward rolling of the vehicle during starting. The minimal thermal requirements of the approach are advantageous, since the valves are energized for a maximum of 2 seconds.

Similar to the first version mentioned, a method for immediately closing the switchover valve while the vehicle is at a standstill is described according to FIG. 4. In contrast to the first version mentioned, however, the switchover valve is energized only by a minimum current iUSV1, thereby closing the switchover valve without pressure. The minimum current may be selected in such a way that the valve just remains closed, for example, against a difference pressure of 5 bar. This is sufficient, since no pressure drop is present across the switchover valve in the state “driver braking at a standstill”. Only when the driver releases the brake is the current set to the required setpoint current iUSV2 for maintaining pressure.

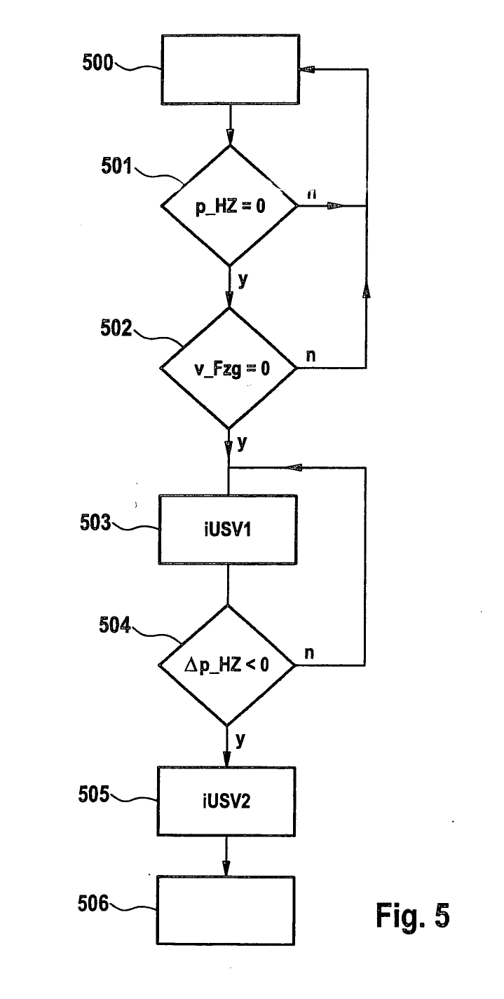

The sequence of the method according to the present invention is illustrated in FIG. 5. After starting in block 500, a query in block 501 checks whether the driver is operating the brake. This may be done, for example, by checking whether the brake pressure in the main brake cylinder has exceeded a threshold value. If the answer is “no” (always identified by “n” in FIG. 5), the method branches back to block 500. If the answer is “yes” (always identified by “y” in FIG. 5), a query in block 502 subsequently checks whether the vehicle is at a standstill. If the answer is “no”, the method branches back to block 500.

If the answer is “yes”, the switchover valve is subsequently activated via a first current intensity iUSV1 in block 503. A query in block 504 subsequently checks whether the driver has reduced the intensity of brake pedal operation. This may be done, for example, by checking whether a negative variation in brake pressure has occurred in the main brake cylinder. If the answer is “no”, the method branches back to block 503. If the answer is “yes”, the switchover valve is subsequently activated via a second current intensity iUSV2 in block 505. The second current intensity is selected in such a way that the switchover valve closes more forcefully or more securely than at the first current intensity.

The method according to the present invention ends in Block 506.

1-9. (canceled)

10. A method for activating a switchover valve of a brake circuit, which is configured to build up brake pressure independently of a driver brake operation within the context of a vehicle standstill-holding function, the method comprising:
detecting a vehicle standstill; and
as long as the driver operates the brake during the vehicle standstill, activating the switchover valve via a first current intensity other than zero during a first phase, and activating the switchover valve via a second current intensity other than zero and different from the first current intensity during a subsequent second phase.

11. The method of claim 10, wherein the first current intensity (iUSV1) is selected so that the switchover valve just closes at this current intensity, and wherein the second current intensity (iUSV2) is selected so that the switchover valve is securely closed at this current intensity.

12. The method of claim 11, wherein the switchover valve is a open valve when currentless and the second current intensity (iUSV2) is higher than the first current intensity (iUSV1).

13. The method of claim 10, wherein the transition to the second phase takes place when the driver reduces the intensity of brake operation.

14. The method of claim 10, wherein the first current intensity (iUSV1) is selected so that the switchover valve just closes when a predefined pressure difference is present at the valve.

15. The method of claim 14, wherein the predefined pressure difference is a small pressure difference.

16. The method of claim 15, wherein the predefined pressure difference is a pressure difference between 2 bar and 8 bar.

17. The method of claim 10, wherein the brake circuit is a hydraulic brake circuit.

18. The method of claim 15, wherein the predefined pressure difference is a pressure difference of about 5 bar.

19. A device for activating a switchover valve of a brake circuit, which is configured to build up brake pressure independently of a driver brake operation within the context of a driver standstill holding function, comprising:
a standstill detection arrangement to detect a vehicle standstill;
a brake operation detection arrangement to detect an operation of the brake by the driver;
an energizing arrangement to energize the switchover valve, the energizing arrangement being configured so that, as long as the driver operates the brake during the standstill, the switchover valve is activated via a first current intensity (iUSV1) other than zero during a first phase, and the switchover valve is activated via a second current intensity (iUSV2) other than zero and different from the first current intensity (iUSV1) during a subsequent second phase.

20. The device of claim 19, wherein the first current intensity (iUSV1) is selected so that the switchover valve just closes at this current intensity, and wherein the second current intensity (iUSV2) is selected so that the switchover valve is securely closed at this current intensity.

21. The device of claim 20, wherein the switchover valve is a open valve when currentless and the second current intensity (iUSV2) is higher than the first current intensity (iUSV1).

22. The device of claim 19, wherein the transition to the second phase takes place when the driver reduces the intensity of brake operation.

23. The device of claim 19, wherein the first current intensity (iUSV1) is selected so that the switchover valve just closes when a predefined pressure difference is present at the valve.

24. The device of claim 23, wherein the predefined pressure difference is a small pressure difference.

25. The device of claim 24, wherein the predefined pressure difference is a pressure difference between 2 bar and 8 bar.

26. The device of claim 19, wherein the brake circuit is a hydraulic brake circuit.

27. The device of claim 24, wherein the predefined pressure difference is a pressure difference of about 5 bar.
